(19) United States
(12) Patent Application Publication
(10) Pub. No.: US 2026/0134036 A1
(43) Pub. Date: May 14, 2026

(54) QUERY SEGMENTATION AND ENTITY LINKING WITH LARGE LANGUAGE MODELS

(71) Applicant: DoorDash, Inc., San Francisco, CA (US)

(72) Inventors: Omar Eduardo Martinez Villeda, San Francisco, CA (US); Ran He, Great Neck, NY (US); Paul Kim, Los Angeles, CA (US)

(73) Assignee: DoorDash, Inc., San Francisco, CA (US)

(21) Appl. No.: 19/382,645

(22) Filed: Nov. 7, 2025

Related U.S. Application Data
(60) Provisional application No. 63/718,205, filed on Nov. 8, 2024.

(51) Int. Cl. G06F 16/9032; G06F 16/2457; G06F 16/903; G06F 16/93

(52) U.S. Cl. CPC G06F 16/90332; G06F 16/24578; G06F 16/90335; G06F 16/93

(57) ABSTRACT

A computer receives a query from an end user device. The computer determines a segmentation result based on the query using a first language model. The computer determines a query embedding based on the query. The computer determines a plurality of candidate labels based on the query embedding. The computer determines a linking result based on the query and the plurality of candidate labels using a second language model. The computer retrieves one or more documents from a documents database using the linking result and the segmentation result. The computer provides the one or more documents to the end user device.

### CROSS-REFERENCES TO RELATED APPLICATIONS

This application claims the benefit of U.S. Provisional Application No. 63/718,205, filed Nov. 8, 2024, which is herein incorporated by reference in its entirety for all purposes.

### SUMMARY

One embodiment is related to a method comprising: receiving, by a computer, a query from an end user device; determining, by the computer, a segmentation result based on the query using a first language model; determining, by the computer, a query embedding based on the query; determining, by the computer, a plurality of candidate labels based on the query embedding; determining, by the computer, a linking result based on the query and the plurality of candidate labels using a second language model; retrieving, by the computer, one or more documents from a documents database using the linking result and the segmentation result; and providing, by the computer, the one or more documents to the end user device.

Another embodiment is related to a computer comprising: a processor; and a non-transitory computer readable medium comprising code, executable by the processor for performing operations comprising: receiving a query from an end user device; determining a segmentation result based on the query using a first language model; determining a query embedding based on the query; determining a plurality of candidate labels based on the query embedding; determining a linking result based on the query and the plurality of candidate labels using a second language model; retrieving one or more documents from a documents database using the linking result and the segmentation result; and providing the one or more documents to the end user device.

Another embodiment is related to a system comprising: an end user device; a documents database; and a central server computer comprising: a processor; and a non-transitory computer readable medium comprising code, executable by the processor for performing operations comprising: receiving a query from the end user device; determining a segmentation result based on the query using a first language model; determining a query embedding based on the query; determining a plurality of candidate labels based on the query embedding; determining a linking result based on the query and the plurality of candidate labels using a second language model; retrieving one or more documents from the documents database using the linking result and the segmentation result; and providing the one or more documents to the end user device.

Further details regarding embodiments of the disclosure can be found in the Detailed Description and the Figures.

### BRIEF DESCRIPTION OF THE DRAWINGS

FIG. 1A shows a block diagram of a system according to embodiments.

FIG. 1B shows a flow diagram illustrating a delivery process according to embodiments.

FIG. 2 shows a block diagram of components of a central server computer according to embodiments.

FIG. 3 shows a flowchart of a first part of a search and retrieval method according to embodiments.

FIG. 4 shows a flowchart of a second part of a search and retrieval method according to embodiments.

FIG. 5 shows a flowchart of a document retrieval method according to embodiments.

### DETAILED DESCRIPTION

Prior to discussing embodiments of the disclosure, some terms can be described in further detail.

An “item” can be an individual article or unit. Examples of items can include perishable items such as food items, beauty items (e.g., cosmetics), office supply products (e.g., staples, paper, and ink), hardware items (e.g., nails, hammers, wrenches), electronic devices (e.g., computers, phones, etc.), jewelry, etc.

A “user” may include an individual or a computational device. In some embodiments, a user may be associated with one or more personal accounts and/or mobile devices. In some embodiments, the user may be a consumer or a customer.

A “user device” may be a device that is operated by a user. In some embodiments, the user device can be an electronic device that can process information and communicate with other electronic devices. A user device may include a processor and a computer-readable medium coupled to the processor, the computer-readable medium comprising code, executable by the processor. Examples of user devices may include a mobile device, a laptop or desktop computer, a wearable device, etc.

A “transporter” can be an entity that transports something. A transporter can be a person that transports an item using a transportation device (e.g., a car). In other embodiments, a transporter can be a transportation device that may or may not be operated by a human. Examples of transportation devices include cars, boats, scooters, bicycles, drones, airplanes, etc. In some embodiments, the transporter user device can be integrated into a transportation device.

A “fulfillment request” can be a request to provide a resource in response to a request. For example, a fulfillment request can include an initial communication from an end user device to a central server computer for a first service provider computer to fulfill a purchase request for a resource such as food. A fulfillment request can be in an initial state, a completed state, or a final state. A fulfillment request can include one or more selected items that a user wishes to obtain from a selected service provider.

A “delivery order” can include a request to deliver one or more items. Delivery orders can include requests to provide one or more items from a pickup location to a drop-off location. Delivery orders can include orders to deliver items from service provider locations to end user locations. Delivery orders can include orders to deliver items from end user locations to service provider locations. An example of this type of delivery order can be a return order (e.g., to deliver an item that is to be returned). A delivery order can include data to fulfill the delivery request including an order type, an indication of an item, a pickup location, and a drop-off location. In some embodiments, the delivery order can include a scheduling range by which the order is to be fulfilled. A delivery order can also include metadata. The metadata can include data relating to the delivery order (e.g., related order numbers, instruction data, etc.).

A “route” can include a way or course taken in getting from a starting point to a destination. For example, a route can indicate a path that can be followed to move from a pickup location to a drop-off location. In some embodiments, a route can indicate a suggested path that a transporter can follow to deliver an item from a service provider to an end user (or vice-versa) for a delivery order. In some embodiments, a route can be referred to as a journey. In some embodiments, a central server computer can route and automatically control (e.g., using a route map and control signals) an autonomous vehicle according to pick up an item from a service provider and deliver it to an end user.

A “query” can include a request for information. A query can include an instruction provided by a user or a user device to a computer system. In some embodiments, a query may comprise textual, voice, or structured data input that expresses the user's intent to search, retrieve, or interact with information. A query may include keywords, phrases, questions, or commands, and may be accompanied by metadata such as user information, device type, location, or historical context. The query may be processed by computational models or algorithms to generate responses, retrieve documents, or perform actions relevant to the user's intent.

A “segmentation result” can include results from a segmentation related process. A segmentation result can include one or more generated labels that relate to a query. A segmentation result can include generated labels that are generated by a large language model based on a query. The generated labels may not be directly indexed in a database, however, they may match a known label, but are not indexed (e.g., linked) to the known label.

A “linking result” can include results from a linking related process. A linking result can include one or more known labels that relate to a query. A linking result can include known labels that are selected by a large language model based on a query from a list of candidate labels that originate from a label database or other label storage means. The known labels can be indexed in a database, as such, a computer can search a database using a known label.

A “label” can include an identifier, classification, or descriptor that is associated with something. A label can be associated with data, an item, or a document. In some embodiments, a label may comprise textual, numerical, categorical, or symbolic information representing a property, category, class, or characteristic of the associated entity. A label may be manually assigned, automatically generated, or predicted by a machine learning model, and may be used for data organization, classification, search, information retrieval, or machine learning processes. Labels may be accompanied by metadata such as confidence scores, timestamps, etc. As an illustrative example, a label can be a dish type of chicken wings, a dish type of pizza, a dish type of pasta, a dietary preference of vegan, a dietary preference of gluten free, a cuisine of Mexican cuisine, a cuisine of Japanese cuisine, etc.

A “document” can include a record, file, or data structure that contains information. A document can contain content and/or data. A document can be stored, processed, or transmitted by a computer system. In some embodiments, a document may comprise textual, graphical, audio, video, structured, or unstructured data. A document may represent a discrete unit of information, such as a file, record, message, web page, form, or dataset, and may be associated with metadata such as creation time, author, document type, or classification. A document may be created, modified, stored, retrieved, processed, or displayed by one or more computer systems or user devices. A document can represent an item or a store. For example, a document can include data related to an item that is provided by a resource provider to an end user.

A “machine learning computer” can include a device that creates, trains, and/or otherwise manipulates models. A machine learning computer can train a machine learning model.

A “machine learning model” (ML model) can include a software module configured to be run on one or more processors to provide a classification or numerical value of a property of one or more samples. An ML model can include various parameters (e.g., for coefficients, weights, thresholds, functional properties of function, such as activation functions). As examples, an ML model can include at least 10, 100, 1,000, 5,000, 10,000, 50,000, 100,000, or one million parameters. An ML model can be generated using sample data (e.g., training samples) to make predictions on test data. Various number of training samples can be used, e.g., at least 10, 100, 1,000, 5,000, 10,000, 50,000, 100,000, or at least 200,000 training samples. One example is an unsupervised learning model such as hidden Markov model (HMM), clustering (e.g., hierarchical clustering, k-means, mixture models, model-based clustering, density-based spatial clustering of applications with noise (DBSCAN), and OPTICS algorithm), approaches for learning latent variable models such as Expectation-maximization algorithm (EM), method of moments, and blind signal separation techniques (e.g., principal component analysis, independent component analysis, non-negative matrix factorization, singular value decomposition), and anomaly detection (e.g., local outlier factor and isolation forest). Another example type of model is supervised learning that can be used with embodiments of the present disclosure. Example supervised learning models may include different approaches and algorithms including analytical learning, statistical models, artificial neural network (e.g. including convolutional and/or transformer layers) that may have 1-10 layers as examples, recurrent neural network (e.g., long short term memory, LSTM), boosting (meta-algorithm), bootstrap aggregating (bagging) such as random forests, support vector machine (SVM), support vector (SVR), Bayesian statistics, case-based reasoning, decision tree learning, inductive logic programming, linear regression, logistic regression, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), ordinal classification, data pre-processing, handling imbalanced datasets, statistical relational learning, or Proaftn (a multicriteria classification algorithm), or an ensemble of any of these types. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

A “deep neural network (DNN)” may be a neural network in which there are multiple layers between an input and an output. Each layer of the deep neural network may represent a mathematical manipulation used to turn the input into the output. In particular, a “recurrent neural network (RNN)” may be a deep neural network in which data can move forward and backward between layers of the neural network.

An “encoder” can process an input sequence to create a vector. Encoders can process input sequences to generate embedding vectors. An encoder can encode data from a higher dimensionality to a lower dimensionality. A “decoder” can process a vector to create an output sequence. Decoders can process embedding vectors, or vectors modified therefrom, to generate an output sequence. A decoder can decode data from a lower dimensionality to a higher dimensionality. Both encoders and decoders can be separate, fully connected neural networks. Encoders and decoders may be recurrent neural networks (RNNs) or variants thereof (e.g., long-short term memory (LSTM), gated recurrent units (GRUs), etc.) and convolutional neural networks (CNNs), as well as transformer models. An encoder-decoder model can include several encoders and several decoders.

A “model database” may include a database that can store machine learning models. Machine learning models can be stored in a model database in a variety of forms, such as collections of parameters or other values defining the machine learning model. Models in a model database may be stored in association with keywords that communicate some aspect of the model. For example, a model used to evaluate news articles may be stored in a model database in association with the keywords “news,” “propaganda,” and “information.” A machine learning computer can access a model database and retrieve models from the model database, modify models in the model database, delete models from the model database, or add new models to the model database.

A “feature vector” may include a set of measurable properties (or “features”) that represent some object or entity. A feature vector can include collections of data represented digitally in an array or vector structure. A feature vector can also include collections of data that can be represented as a mathematical vector, on which vector operations such as the scalar product can be performed. A feature vector can be determined or generated from input data. A feature vector can be used as the input to a machine learning model, such that the machine learning model produces some output or classification. The construction of a feature vector can be accomplished in a variety of ways, based on the nature of the input data. For example, for a machine learning classifier that classifies words as correctly spelled or incorrectly spelled, a feature vector corresponding to a word such as “LOVE” could be represented as the vector (12, 15, 22, 5), corresponding to the alphabetical index of each letter in the input data word. For a more complex “input,” such as a human entity, an exemplary feature vector could include features such as the human's age, height, weight, a quantitative representation of relative happiness, etc. Feature vectors can be represented and stored electronically in a feature store. Further, a feature vector can be normalized (i.e., be made to have unit magnitude). As an example, the feature vector (12, 15, 22, 5) corresponding to “LOVE” could be normalized to approximately (0.40, 0.51, 0.74, 0.17).

A “language model” can include can include a computational model trained on natural language datasets. A language model can include a large language model (LLM). A language model can be configured to generate, interpret, or analyze language. A language model may comprise a neural network architecture, such as a transformer-based model, having hundreds of millions or more parameters. A language model may be trained using supervised, unsupervised, or self-supervised learning techniques, and may be capable of performing tasks including natural language understanding, text generation, translation, summarization, question answering, and semantic search.

An “embedding” can include numerical representations. An embedding can include a vector. An embedding can be a lower-dimensional vector that is derived from complex high-dimensional data.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

Conventional search systems are limited in their ability to accurately interpret and disambiguate user queries due to a lack of contextual understanding. When queries are analyzed in isolation, without the benefit of domain-specific or general knowledge, search systems are often unable to discern the precise intent of the user, particularly when the queries are ambiguous or compound multiple requirements. For example, a query such as “turkey sandwich with cranberry sauce” may be ambiguous to a search system as it is unclear whether “cranberry sauce” is intended as a separate item or as an attribute of the “sandwich.” This ambiguity can result in the retrieval of results that include any turkey sandwich and any cranberry sauce separately, rather than exclusively retrieving turkey sandwiches that include cranberry sauce. The ability of a search system to understand a query with greater accuracy directly correlates with its ability to retrieve relevant and useful results.

Current approaches to query analysis, such as traditional query segmentation using pointwise mutual information (PMI) and n-gram analysis, segment queries based on statistical co-occurrence of terms. However, these methods are inadequate for handling complex or ambiguous queries as they fail to capture contextual relationships between words. Manual segmentation and linking of queries to concepts is possible, but this process is labor-intensive and does not scale efficiently for large-scale systems. Embedding-based retrieval methods, which attempt to match queries and documents based on vector similarity, often retrieve irrelevant results due to insufficient control over specific attributes. Similarly, statistical methods such as best matching 25 (BM25) and rule-based retrieval systems lack the depth of contextual understanding necessary for achieving high-precision results.

These limitations manifest as an inability to adequately handle complex queries, scalability challenges, and a dependence on extensive manual intervention to maintain acceptable levels of precision. Embodiments solve such technical problems.

One technical problem faced by current search systems is the difficulty in processing user queries that express precise, multi-faceted requirements. Users increasingly formulate queries that combine multiple attributes or constraints, and existing systems struggle to generalize to previously unseen queries while simultaneously enforcing rules needed to ensure the quality and relevance of search results.

For instance, in the case of a query such as “vegan chicken sandwich,” an embedding-based retrieval system may return a range of results, including vegan sandwiches, vegetarian sandwiches, chicken sandwiches, and vegan chicken sandwiches. However, only the set of results corresponding to vegan chicken sandwiches fully matches the user's intent. Furthermore, user preferences may differ regarding the importance of various attributes. For example, a user may be willing to consider any vegan sandwich as an alternative, but would reject any chicken sandwich that is not vegan. Generally, dietary restrictions or other critical attributes take precedence over less significant attributes, such as protein type. To deliver only the most relevant results, embodiment can enforce attribute-based rules while maintaining flexibility to accommodate varying user preferences.

Embodiments provide a hybrid search architecture designed to address these technical problems. Embodiments integrate keyword-based retrieval techniques with robust document and query understanding mechanisms. Such systems enable the enforcement of specific rules (e.g., ensuring only vegan items are retrieved) while maintaining sufficient flexibility to generalize a broad range of user queries and preferences.

In general, the search engine can be organized into two phases: 1) document processing and 2) query processing. Documents, which may include item pages or store pages, are prepared and indexed for subsequent retrieval. Queries represent the search terms or instructions entered by users.

A first step in the search process can include query understanding, typically performed by a query understanding module. The query understanding module may involve parsing and segmenting the query into meaningful components, annotating the query with additional information, linking segments to specific concepts, correcting spelling errors, and predicting the intent of the query (e.g., distinguishing between grocery and restaurant items).

On the document side, embodiments provide for the preprocessing and annotation of documents with metadata prior to indexing. This metadata may enrich the document, thereby supporting advanced search functionalities and enabling features such as filtering and analytics.

In some embodiments, knowledge graphs are utilized to define relationships between entities, such as food items and retail products. Knowledge graphs can facilitate a deeper understanding of documents by associating them with rich metadata, including tags and attributes such as brand, dietary preference, flavor, and category.

For example, a document corresponding to “XYZ's Non-Dairy Milk & Cookies Vanilla Frozen Dessert—16 oz” may have associated metadata indicating the brand (XYZ), dietary preference (dairy-free), flavor (vanilla), and category (ice cream).

Similarly, user queries can be segmented and linked to concepts represented within the knowledge graph. For instance, a query such as “XYZ no milk vanilla ice cream” may be segmented into components such as [“XYZ”, “no milk”, “vanilla ice cream” ], with each segment linked to document attributes.

However, the precise linking of query segments to document attributes presents technical challenges, particularly when the granularity of the segments varies. For example, the segment “vanilla ice cream” can be mapped to both a “dish type” attribute (“ice cream”) and a “flavor” attribute (“vanilla”). Embodiments address these technical challenges by providing technical solutions that are context-aware and capable of accurate segmentation and entity linking, thereby supporting precise and attribute-sensitive search and retrieval.

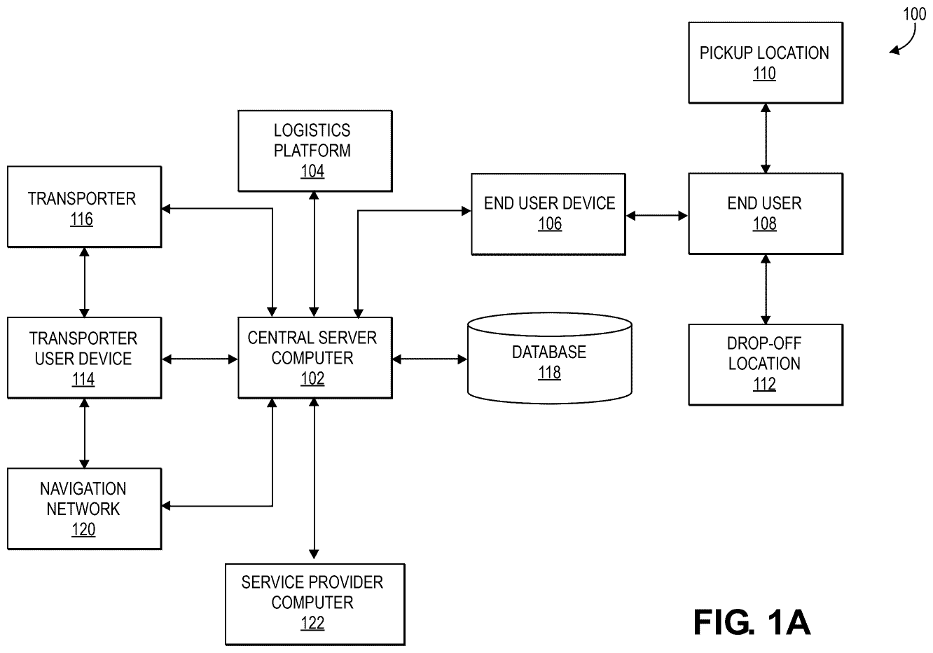

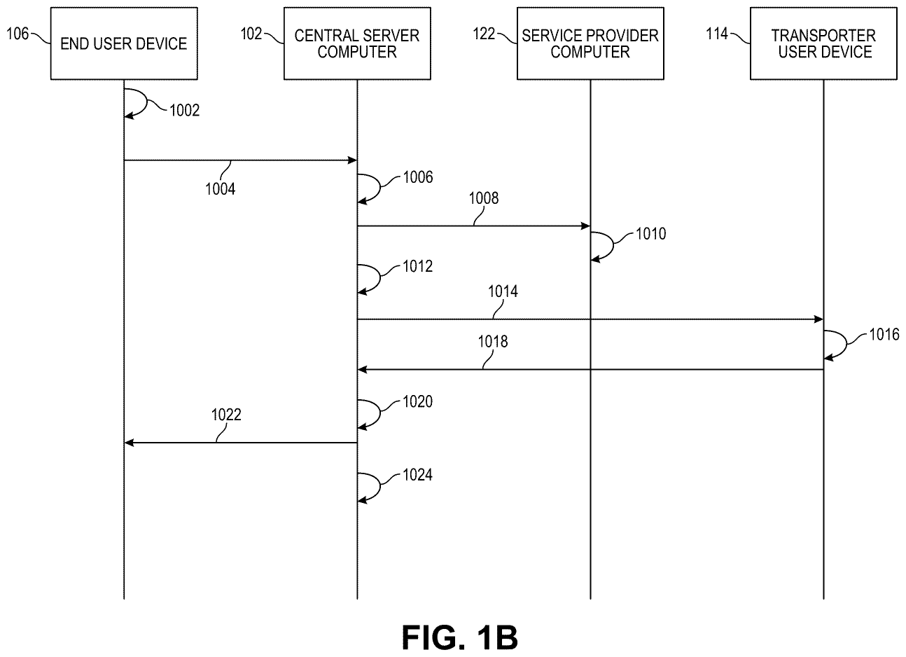

FIG. 1A shows a system 100 according to embodiments of the disclosure. The system of FIG. 1A includes a central server computer 102, a logistics platform 104, an end user device 106, an end user 108, a pickup location 110, a drop-off location 112, a transporter user device 114, a transporter 116, a navigation network 120, a service provider computer 122, and a database 118.

The central server computer 102 can be in operative communication with the logistics platform 104, the end user device 106, the transporter user device 114, the navigation network 120, the service provider computer 122, and the database 118. The transporter user device 114 can be in operative communication with the navigation network 120.

For simplicity of illustration, a certain number of components are shown in FIG. 1A. It is understood, however, that embodiments of the invention may include more than one of each component. In addition, some embodiments of the invention may include fewer than or greater than all of the components shown in FIG. 1A. For example, although FIG. 1A shows a transporter 116, there can be two, three, or more transporters, transporter user devices, etc. present in the system 100.

Messages between the devices and the computers in the system 100 in FIG. 1 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The central server computer 102 can include a server computer that can facilitate in the fulfillment of fulfillment requests received from the end user device 106. For example, the central server computer 102 can identify the transporter 116 (from among many candidate transporters) operating the transporter user device 114 as being suitable for satisfying the fulfillment request. The central server computer 102 can identify the transporter user device 114 that can satisfy the fulfillment request based on any suitable criteria (e.g., transporter location, service provider location, end user destination, end user location, transporter mode of transportation, etc.).

The central server computer 102 can receive data relating to a delivery order of items from the service provider computer 122 to the end user 108 at the drop-off location 112. The central server computer 102 can determine a route for delivery of the delivery order. The central server computer 102 can present the routes to a plurality of transporter user devices and/or transporters. The central server computer 102 can receive acceptances from the transporter 116 that will deliver the items from the pickup location 110 to the drop-off location 112.

The central server computer 102 can receive a query from the end user device 106. The central server computer 102 can determine one or more documents based on the query. The central server computer 102 can provide the one or more documents to the end user device 106.

The logistics platform 104 can include a location determination system, which can determine the locations of various user devices such as transporter user devices (e.g., the transporter user device 114) and end user devices (e.g., the end user device 106). The logistics platform 104 can also include routing logic to efficiently route transporters using the transport user devices to various pickup locations that have the packages that are to be delivered to drop-off locations. Efficient routes can be determined based on the locations of the transporters, the locations of the pickup locations, the locations of the drop-off locations, as well as external data such as traffic patterns, the weather, etc. The logistics platform 104 can be part of the central server computer 102 or can be system that is separate from the central server computer 102.

The end user device 106 can include a device operated by the end user 108. The end user devices 106 can generate and provide fulfillment request messages to the central server computer 102. The fulfillment request message can indicate that the request (e.g., a request for a service) can be fulfilled by the service provider computer 122. For example, the fulfillment request message can be generated based on a cart selected at checkout during a transaction using a central server computer application installed on the end user device 106. The fulfillment request message can include one or more items from the selected cart.

The end user device 106 can provide a fulfillment request message to the central server computer 102 that indicates that the end user device 106 is requesting that the transporter 116 pick up an item from the pickup location 110 (e.g., end user's 108 location) and deliver the item to the drop-off location 112 (e.g., the service provider computer's 122 location).

The pickup location 110 can be a location in which items are stored. In the context of an outbound delivery from an end user at an end user location, examples of the pickup location 110 may be a house or an apartment, a mailbox, a service provider location (e.g., a retail store, a grocery store, a dry cleaning store), a pickup hub, etc. Items can first be obtained from a pickup location 110 and then be transported to the drop-off location 112. Examples of the drop-off location 112 can be similar to the pickup location 110, such a house or apartment, a mailbox, a retail store, a grocery store, a dry cleaning store, a pickup hub, etc. In one example, the pickup location 110 can be a pizza parlor from which the end user 108 orders a pizza. The drop-off location 112 can be an apartment in which the end user 108 resides.

The transporter user device 114 can include a device operated by the transporter 116. The transporter user device 114 can include a smartphone, a wearable device, a personal assistant device, etc. The transporter 116 can accept an end user's fulfillment request via an acceptance message. For example, the transporter user device 114 can generate and transmit a request to fulfil a particular end user's fulfillment request to the central server computer 102. The central server computer 102 can notify the transporter user device 114 of the fulfillment request. The transporter user device 114 can respond to the central server computer 102 with a request to perform the delivery to the end user as indicated by the fulfillment request.

In some embodiments, the transporter 116 can be an operator of a vehicle. In other embodiments, the transporter 116 can be a vehicle that can operated by an operator or can be autonomous. The vehicle can include a car, a truck, a van, a motorcycle, a bicycle, a drone, or other vehicle.

The navigation network 120 can provide navigational directions to the transporter user device 114. For example, the transporter user device 114 can obtain a location from the central server computer 102. The location can be a service provider parking location, a service provider location, an end user parking location, an end user location, etc. The navigation network 120 can provide navigational data to the location. For example, the navigation network 120 can be a global positioning system that provides location data to the transporter user device 114.

The service provider computer 122 include computers operated by a service provider. For example, the service provider computer 122 can be a food provider computer that is operated by a food provider. The service provider computer 122 can offer to provide services to the end user 108 of the end user device 106. In embodiments of the invention, the service provider computer 122 can receive requests to prepare one or more items for delivery from the central server computer 102. The service provider computer 122 can initiate the preparation of the one or more items that are to be delivered to the end user 108 of the end user device 106 by the transporter 116 of the transporter user device 114.

The database 118 can include any suitable database. The database may be a conventional, fault tolerant, relational, scalable, secure database such as those commercially available from Oracle™ or Sybase™. The database 118 can store data related to fulfillment requests.

FIG. 1B shows a flow diagram illustrating a preparation and delivery method of an item according to embodiments. The method illustrated in FIG. 1B will be described in the context of the central server computer 102 receiving a fulfillment request message from the end user device 106 to fulfill preparation and delivery of one or more items from a cart to the end user of the end user device 106. The central server computer 102 can communicate with the service provider computer 122 and the transporter user device 114 to fulfill the fulfillment request.

At step 1002, the end user device 106 can decide to check out with a cart in a central server computer delivery application installed on the end user device 106. The end user may have reviewed one or more documents with descriptions of items and/or service providers and may have selected them for purchase. The generation of the documents is described in further detail below. The cart can include one or more items that are provided from a service provider of the service provider computer 122.

At step 1004, after checking out with the cart, the end user device 106 can provide a fulfillment request message including the one or more items from the cart to the central server computer 102. The fulfillment request message can also include a service provider computer identifier that identifies the service provider computer 122.

At step 1006, after receiving the fulfillment request message, the central server computer 102 can perform a transaction process with the end user device 106. For example, the central server computer 102 can communicate with a payment network to process the transaction for the one or more items. The central server computer 102 can receive an indication of whether or not the transaction is authorized. If the transaction is authorized, then the central server computer 102 can proceed with step 1008.

At step 1008, the central server computer 102 can provide the fulfillment request message, or a derivation thereof, to the service provider computer 122. The central server computer 102 can determine which service provider computer of a plurality of service provider computers to communicate with based on the service provider indicated in the fulfillment request message. For example, the fulfillment request message can indicate that the one or more items are provided by the service provider of the service provider computer 122. The central server computer 102 can identify the service provider computer 122 using the service provider computer identifier in the fulfillment request message.

At step 1010, after receiving the fulfillment request message, the service provider computer 122 can initiate preparation of the one or more items. For example, the service provider computer 122 can alert service provider personnel (e.g., those preparing the items) at the service provider location. The service providers can prepare the one or more items for pick up by a transporter.

At step 1012, after providing the fulfillment request message to the service provider computer 122, the central server computer 102 can determine one or more transporters operating one or more user devices that are capable of fulfilling the fulfillment request message. The central server computer 102 can determine the one or more transporters from the transporter user devices. The central server computer 102 can determine the one or more transporter user devices based on whether or not the transporter user device is online, whether or not the transporter user device 114 is already fulfilling a different fulfillment request message, a location of the transporter user device 114, etc.

At step 1014, after determining the one or more transporter user devices, the central server computer 102 can provide the fulfillment request message, or a derivation thereof, to the one or more transporter user devices including the transporter user device 114.

At step 1016, after receiving the fulfillment request message, the transporter of the transporter user device 114 can determine whether or not they want to perform the fulfillment. The transporter can decide that they want to perform the delivery of the one or more items from the service provider location to the end user location. The transporter user device 114 can generate an acceptance message that indicates that the fulfillment request is accepted.

At step 1018, after generating the acceptance message, the transporter user device 114 can provide the acceptance message to the central server computer 102.

After providing the acceptance message to the central server computer 102, the transporter user device 114 can communicate with a navigation network and the transporter can proceed to the service provider location to obtain the one or more items. The transporter user device 114 can then receive input from the transporter that indicates that the transporter obtained the one or more items (e.g., the transporter selects that they picked up the items). The transporter user device 114 can then communicate with the navigation network and the transporter can then proceed to the end user location to provide the one or more items to the end user. In some embodiments, the transporter user device 114 can provide update messages to the central server computer 102 that include a transporter user device 114 location and/or event data (e.g., items picked up, items delivered, etc.).

In some embodiments, after receiving the acceptance message, the central server computer 102 can notify the other transporter user devices that received the fulfillment request message that the fulfillment request is no longer available.

At step 1020, at any point after receiving the acceptance message, the central server computer 102 can check the status of the fulfillment request. For example, the central server computer 102 can determine the location of the transporter user device 114 and can determine an estimated amount of time for the transporter user device 114 to arrive at the end user location.

At step 1022, the central server computer 102 can provide an update message to the end user device 106 that includes data related to the fulfillment of the fulfillment request message. The data can include an estimated amount of time, the transporter user device location, event data (e.g., items picked up from the service provider), and/or other data related to the fulfillment of the fulfillment request message.

At step 1024, the central server computer 102 can store any data received, sent, and/or processed during the fulfillment of the fulfillment request message into a database. For example, the central server computer 102 can store a user's cart selection as user features into a user feature database.

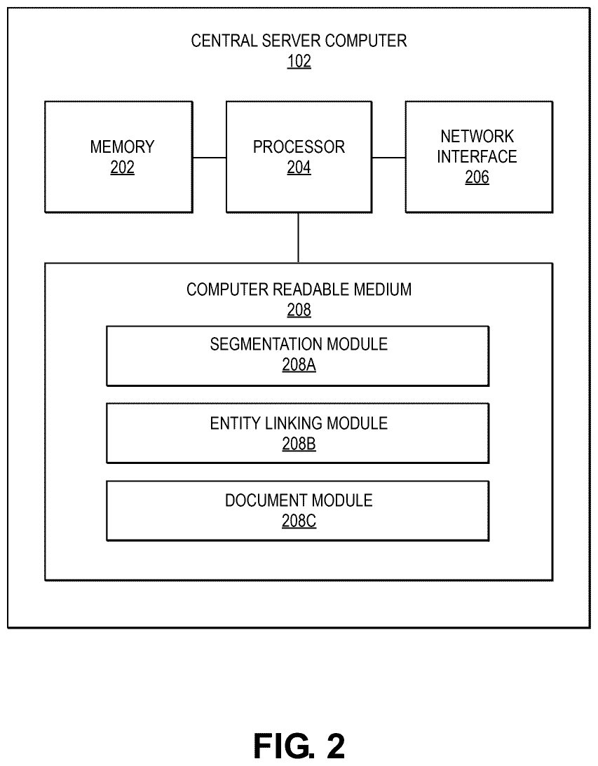

FIG. 2 shows a block diagram of a central server computer 102 according to embodiments. The exemplary central server computer 102 may comprise a processor 204. The processor 204 may be coupled to a memory 202, a network interface 206, and a computer readable medium 208. The computer readable medium 208 can comprise a segmentation module 208A, an entity linking module 208B, and a document module 208C.

The memory 202 can be used to store data and code. For example, the memory 202 can store documents, queries, fulfillment data, etc. The memory 202 may be coupled to the processor 204 internally or externally (e.g., cloud based data storage), and may comprise any combination of volatile and/or non-volatile memory, such as RAM, DRAM, ROM, flash, or any other suitable memory device.

The computer readable medium 208 may comprise code, executable by the processor 204, for performing a method comprising: receiving, by a computer, a query from an end user device; determining, by the computer, a segmentation result based on the query using a first language model; determining, by the computer, a query embedding based on the query; determining, by the computer, a plurality of candidate labels based on the query embedding; determining, by the computer, a linking result based on the query and the plurality of candidate labels using a second language model; retrieving, by the computer, one or more documents from a documents database using the linking result and the segmentation result; and providing, by the computer, the one or more documents to the end user device.

The segmentation module 208A may comprise code or software, executable by the processor 204, for performing segmentation. The segmentation module 208A, in conjunction with the processor 204, can parse and segment a received search query into distinct components or segments. The segmentation module 208A, in conjunction with the processor 204, can large language models or other natural language processing techniques to analyze the semantic structure of the query and identify meaningful phrases, entities, or attributes in the query. In some embodiments, The segmentation module 208A, in conjunction with the processor 204, can identify segments of the query according to identified categories, such as brand, product type, dietary preference, flavor, etc.

The entity linking module 208B may comprise code or software, executable by the processor 204, for linking stored known labels with the query. The entity linking module 208B, in conjunction with the processor 204, can identify and associate portions of a query with known labels (e.g., attributes) that are defined within a knowledge graph or controlled vocabulary. The entity linking module 208B, in conjunction with the processor 204, can utilize a large language model to determine linking results that include one or more known labels of the knowledge graph that relate to the query.

The document module 208C may comprise code or software, executable by the processor 204, for identifying and obtaining documents. The document module 208C, in conjunction with the processor 204, can manage the storage, indexing, and retrieval of documents within a documents database. The document module 208C, in conjunction with the processor 204, can receive linking results and segmentation results from the preceding modules and utilize these to identify and retrieve one or more documents that match the user's query intent. In some embodiments, the document module 208C, in conjunction with the processor 204, can apply additional filtering, ranking, or summarization operations to the retrieved documents.

The network interface 206 may include an interface that can allow the central server computer 102 to communicate with external computers. The network interface 206 may enable the central server computer 102 to communicate data to and from another device (e.g., the logistics platform 104, the end user device 106, the transporter user device 114, the transporter 116, the database 118, the navigation network 120, the service provider computer 122, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

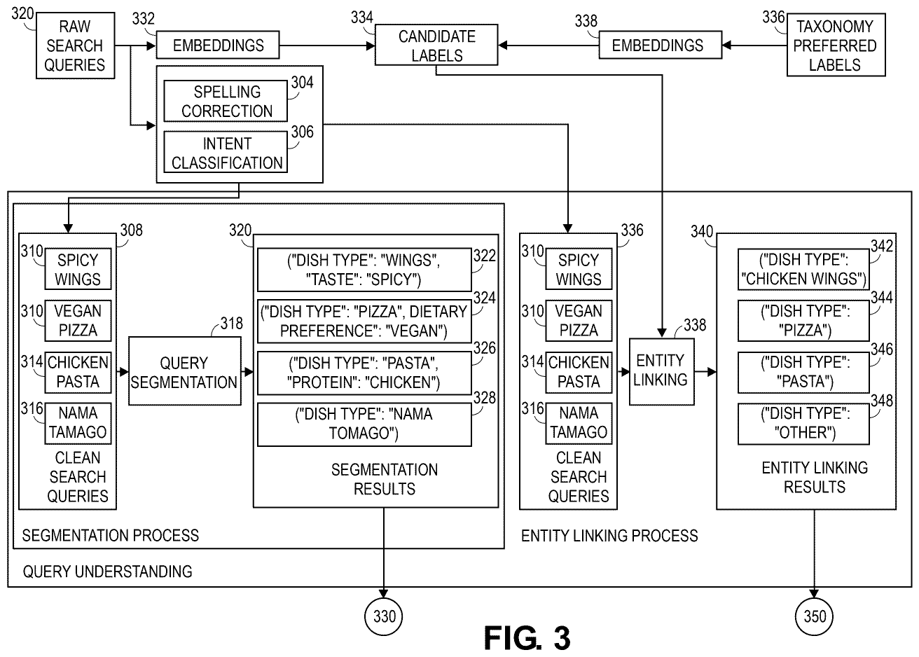

FIG. 3 shows a flowchart of a first part of a search and retrieval method according to embodiments. FIG. 3 illustrates a computer (e.g., the central server computer 102) receiving a query (e.g., from the end user device 106). The computer can determine one or more documents based on the query. The computer can provide the one or more documents to the end user device 106.

At step 302, the computer can receive a query. The computer can receive the query from the end user device 106. In some embodiments, the computer can receive the query from an application installed on the end user device.

The query can include text input into a search bar by a user using the end user device 106. The query can include, for example, “XYZ no milk vanilla ice cream” or “spicy wigns.”

The query can be a raw search query. The computer can perform preprocessing on the raw search query to obtain a clean search query. The computer can perform any suitable preprocessing on the raw search query such as spelling correction, length truncation, summarization, intent classification, etc. Two example preprocessing steps are described at step 304 and step 306.

At step 304, the computer can perform a spelling correction process to correct the spelling of misspelled words in the raw search query. The computer can utilize any suitable spelling correction process.

As an example, the computer can correct the spelling of the query “spicy wigns” to be “spicy wings.”

At step 306, the computer can initiate intent classification to classify the user intent of the query. Intent classification can continue with step 308.

At step 308, the computer can obtain the clean search query (e.g., cleaned during step 304). Four example clean search queries are illustrated in FIG. 3. A first clean search query 310 can be “spicy wings.” A second clean search query 312 can be “vegan pizza.” A third clean search query 314 can be “chicken pasta.” A fourth clean search query 316 can be “nama tamago.”

At step 318, the computer can perform query segmentation. The computer can perform query segmentation on the clean search query using a first large language model (LLM). The first large language model can be specifically configured to parse the search query into meaningful segments that correspond to distinct entities or attributes relevant to the information retrieval system. The computer can generate a segmentation result that includes one or more generated labels. The generated labels can be new labels that are determined by the computer using the first large language model. The generated labels can later aid in filtering documents.

Historically, query segmentation has relied on statistical methods such as Pointwise Mutual Information (PMI) and n-gram analysis to identify word groupings within a query that are likely to form coherent and/or meaningful phrases. While these conventional approaches may be effective for relatively simple queries, they exhibit significant limitations when confronted with complex queries containing multiple or overlapping entities or a high degree of semantic ambiguity. For example, with a query such as “turkey sandwich with cranberry sauce,” traditional techniques may struggle to determine whether “cranberry sauce” is intended as a separate item or as an attribute of the “sandwich,” due to an inability to fully interpret contextual relationships among the terms. This often results in suboptimal segmentation and, consequently, retrieval of less relevant search results.

Large language models offer a substantial improvement over such approaches by leveraging their advanced contextual understanding and extensive pre-training on diverse textual corpora. When provided with appropriate context and guidance, an LLM can accurately interpret and segment complex queries, taking into account the relationships among words and the intended meaning within the specific context of the query. This enables the system to achieve more accurate and context-aware segmentations, thereby improving the relevance of subsequent retrieval operations.

However, a technical challenge associated with the use of LLMs is their propensity to generate plausible but factually incorrect or irrelevant outputs, a phenomenon commonly referred to as “hallucination.” To address this, embodiments can utilize a controlled vocabulary and a preconstructed knowledge graph. The knowledge graph provides an ontology encompassing multiple taxonomies relevant to the domain (e.g., cuisine, dish type, brand, product category, etc.), which are utilized to guide and constrain the segmentation process. By anchoring the LLM's outputs to a structured, domain-specific vocabulary, the system ensures that the segments produced are both factual and useful for downstream information retrieval tasks.

Rather than simply dividing a search query into arbitrary groups of words, the computer can prompt the LLM to identify meaningful segments and to categorize each segment under one of several predetermined taxonomies. This approach not only enhances the interpretability of the segmented query but also immediately classifies each segment in a way that is valuable to the retrieval system. For example, in the context of restaurant items, the computer may access taxonomies defining hierarchical relationships for cuisines, dish types, meal types, and dietary preferences. For retail items, the computer may employ taxonomies for brands, dietary preferences, product categories, and similar attributes.

As an illustrative example, for a query such as “XYZ no milk vanilla ice cream,” the computer, instead of merely segmenting the query into [“XYZ”, “no milk”, “vanilla ice cream” ], can prompt the first large language model to generate a structured output that maps each segment to a corresponding taxonomy category, such as brand, dietary preference, flavor, and product category. The process involves determining relevant taxonomy categories based on the query, selecting or generating a category template that structures the segmentation, generating a prompt that incorporates both the clean search query and the category template, and inputting this prompt into the first large language model. The first large language model can then process the prompt and output a segmentation result (e.g., segments mapped to the predefined taxonomy categories).

In particular, the computer can determine a taxonomy category that is relevant to the query (e.g., the clean search query). For example, the computer can identify that the query is related to food. The computer can obtain taxonomy categories of brand, dietary preference, flavor, product category, cuisine type, or other domain-specific attributes that are defined within the system's knowledge graph or controlled vocabulary. In some embodiments, the determination of taxonomy categories may be performed by analyzing the semantic content of the search query, optionally utilizing natural language processing techniques, entity recognition algorithms, or machine learning models trained to identify salient categories within free-form user input.

After determining the taxonomy category, the computer can determine a category template based on the taxonomy category. The category template can include a structured framework that specifies a template for a prompt based on the category. Each taxonomy category may correspond to a different category template. The computer can obtain the category template from a template database.

The template can be, for example: “determine a value for each field in the following data structure based on the query of [Query], where the data structure is: “{brand: “brand_field”, dietary_preference: “dietary_preference_field”, flavor: “flavor_field”, product category: “product_category_field”}.”

The computer can generate a prompt using the query (e.g., the clean search query) and the category template. The category template serves as a structured input format for input into the first large language model, guiding the first large language model to segment the query and create generated labels. The prompt may be formulated to explicitly request that the LLM map each meaningful segment of the query to a corresponding field in the template, ensuring that the output is both contextually relevant and compatible with the system's controlled vocabulary. This prompt generation process may include additional contextual information, constraints, or examples to further enhance the accuracy and consistency of the LLM's response.

After generating the prompt, the computer can input the prompt into the first large language model. The first large language model can process the prompt using natural language understanding capabilities, determine segments for the query, and assign each segment to the appropriate field as defined by the template. The output produced by the first large language model may consist of a structured mapping of query segments to fields, which can be readily utilized for subsequent retrieval, filtering, or classification operations.

For example, the structured output can be in the following format:

```
{
  Brand: “XYZ”,
  Dietary_Preference: “no milk”,
  Flavor: “vanilla”,
  Product_Category: “ice cream”
}
```

In experimental evaluations, this method resulted in more accurate segmentations. This improvement may occur because the structured categories provide the model with additional context about the space of possible relationships.

At step 320, the computer can determine the segmentation result from the large language model segmentation process. The first large language model can output the segmentation result. FIG. 3 illustrates four example segmentation results that correspond to the four example clean search queries.

A first segmentation result 322 can be a segmentation of the first clean search query 310 of “spicy wings.” The first segmentation result 322 can include generated labels of dish_type:wings and taste:spicy.

A second segmentation result 324 can be a segmentation of the second clean search query 312 of “vegan pizza.” The second segmentation result 324 can include generated labels of dish_type:pizza and dietary_preference:vegan.

A third segmentation result 326 can be a segmentation of the third clean search query 314 of “chicken pasta.” The third segmentation result 326 can include generated labels of dish_type:pasta, protein:chicken.

A fourth segmentation result 328 can be a segmentation of the fourth clean search query 316 of “nama tomago.” The fourth segmentation result 328 can include generated labels of dish_type:nama tamago.

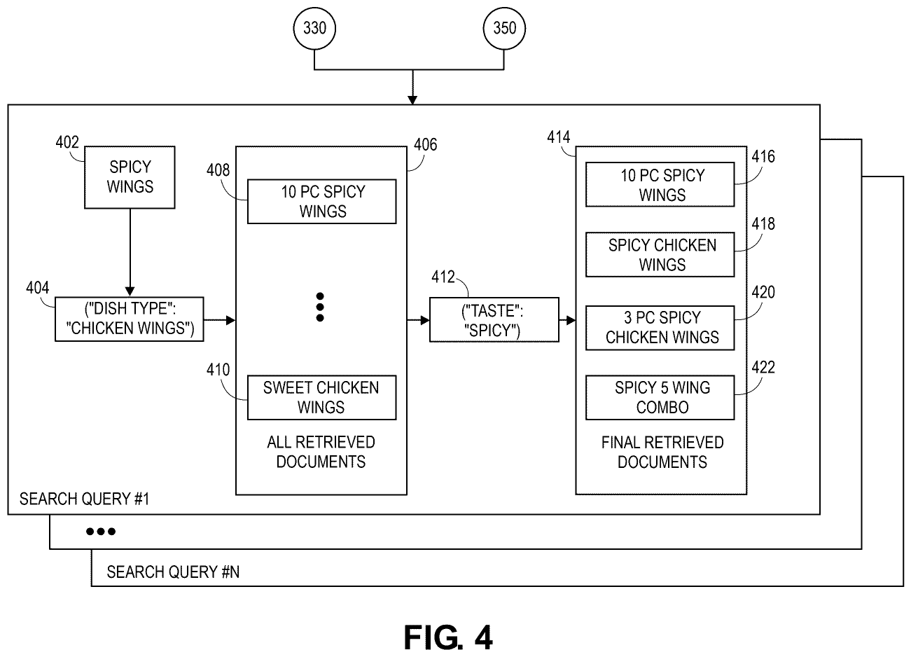

At step 330, the computer can provide the segmentation result to the next phase of the process, which is illustrated in FIG. 4.

At step 332, the computer can determine an embedding for the raw search query. The computer can generate a query embedding based on the raw search query. The query embedding can be a vector representation of the raw search query.

At step 334, after determining the query embedding, the computer can initiate candidate label determination. The computer can determine whether or not previously stored taxonomical labels correspond to the current query. The computer can obtain taxonomy preferred labels from a database at step 336. The computer can determine label embeddings for the taxonomy preferred labels at step 338. In some embodiments, the label embeddings can be stored in the database in association with the taxonomy preferred labels. The computer can compare the query embedding to the label embeddings to determine similar label embeddings which can correspond to candidate labels. The candidate labels are candidates for being related to the query.

For example, once a query has been segmented, the computer can map these segments to concepts available in the knowledge graph (KG). The knowledge graph has been previously ingested into the search index and thus can aid in document retrieval. That means that the computer is making all these rich attributes available for retrieval. Therefore, a segment like “no milk” should be determined by the computer to be linked to the “dairy-free” concept in the knowledge graph because then it can be guaranteed that the computer retrieves a candidate set of items from the index that contain that attribute, but is not restricted to the query needing to have the exact string matching in the item name or description, which can hurt recall.

A second large language model can be utilized to perform such a linking task. However, large language models can sometimes generate outputs that are factually incorrect or hallucinated. In the context of entity linking, this could mean mapping a query segment to a concept that doesn't exist in our knowledge graph or mislabeling it entirely. To mitigate this technical problem, embodiments employ techniques that constrain the model's output to only include concepts within the controlled vocabulary (e.g., the taxonomy concepts).

These types of errors are reduced by providing the second large language model with the curated list of candidate labels retrieved via approximate nearest neighbor (ANN) techniques. This approach ensures that the large language model selects from concepts already part of the knowledge graph, maintaining consistency and accuracy in the mapping.

For the example of the query segment “no milk,” the ANN retrieval system can provide candidate labels such as “dairy-free” or “vegan.” Then, the large language model only needs to select the most appropriate concept based on the context, ensuring that the final mapping is accurate and within the knowledge graph.

At step 336, the computer can obtain the clean search query that was obtained at step 308. FIG. 3 illustrates the four example clean search queries, including the first clean search query 310, the second clean search query 312, the third clean search query 314, and the fourth clean search query 316.

As an illustrative example, the computer can utilize a retrieval-augmented generation (RAG). For each search query and knowledge graph taxonomy concept (e.g., candidate label), the computer can produce embeddings. The embeddings can be from closed-source models, can be pre-trained, or can be learned. Then, using the ANN retrieval system, the computer can retrieve the closest 100 taxonomy concepts (e.g., candidate labels) for each search query. This can be performed due to context window limitations and to reduce the noise in the prompt which can degrade performance. The computer can then prompt the second large language model to link queries to corresponding entities from specific taxonomies (e.g. dish types, dietary preferences, brands, etc.).

At step 338, the computer can utilize the second large language model to determine entity linking results based on the clean search query and the candidate labels. For example, the computer can generate a prompt based on the clean search query and the candidate labels. The computer can provide the prompt to the second large language model to generate entity linking results.

At step 340, the computer can obtain a set of linked taxonomy concepts for each query that the computer can directly use to retrieve documents from the search index.

As an example, a first linking result 342 can be a linking of the first clean search query 310 “spicy wings” to known label(s). The first linking result 342 can include the known label of dish_type:chicken wings.

A second linking result 344 can be a linking of the second clean search query 312 “vegan pizza” to known label(s). The second linking result 344 can include the known label of dish_type:pizza.

A third linking result 346 can be a linking of the third clean search query 314 “chicken pasta” to known label(s). The third linking result 346 can include the known label of dish_type:pasta.

A fourth linking result 348 can be a linking of the fourth clean search query 316 “nama tomago” to known label(s). The fourth linking result 348 can include the known label of dish_type:other.

At step 350, the computer can provide the linking result to the next phase of the process, which is illustrated in FIG. 4.

FIG. 4 shows a flowchart of a second part of a search and retrieval method according to embodiments. After obtaining the segmentation result and the linking result the computer can obtain one or more documents using the segmentation result and the linking result for the query.

After the method described in reference to FIG. 3, the final query understanding signal for the query of, for example, “XYZ no milk vanilla ice cream” would exactly match that of the document (e.g., item) in the catalog of documents “XYZ's Non-Dairy Milk & Cookies Vanilla Frozen Dessert—16 oz”: {Brand: “XYZ”, Dietary_Preference: “Dairy-Free”, Flavor: “Vanilla”, Product_Category: “Ice cream” }.

This can make it easier for the computer to control what to retrieve by implementing a specific retrieval logic, such as making all dietary restrictions a MUST condition at retrieval and allowing flexibility of less strict attributes such as flavors, a SHOULD condition.

The computer can retrieve documents from a documents database based on the linking result and the segmentation result. For example, for a query 402 of “spicy wings,” the computer can retrieve one or more documents.

At step 404, the computer can utilize the linking result, which indicates a particular known label that is used to index documents in the documents database, to retrieve all documents associated with the label. For example, the computer can utilize the label of {dish_type:chicken wings} to obtain all documents in the document database stored in association with the chicken wings label.

Retrieved documents 406 can include one or more documents related to the label. For example, a first document 408 can be a document for “10 pc spicy wings.” A second document 410 can be a document for “sweet chicken wings.”

At step 412, the computer can utilize the segmentation result to filter the retrieved documents 406. For example, the computer can filter the retrieved documents 406 using the segment of {taste:spicy}. The computer can filter the retrieved documents 406 using a string-matching process to remove documents from the retrieved documents 406 that do not include the string “spicy.”

After filtering the retrieved documents 406, the computer can obtain final retrieved documents 414. The final retrieved documents 414 can include any number of documents from the retrieved documents 406. For example, the final retrieved documents 414 can include four documents. A first final document 416 can include a document of “10 pc spicy wings,” which can be the same as the first document 408. A second final document 418 can include a document of “spicy chicken wings.” A third final document 420 can include a document of “3 pc spicy chicken wings.” A fourth final document 422 can include a document of “spicy 5 wing combo.” The second document 410 of “sweet chicken wings” may not be in the final retrieved documents 414 because it does not include the string “spicy” based on filter created from the segmentation result.

After obtaining the final retrieved documents 414, the computer can provide the final retrieved documents 414 to the end user device in response to the query.

As an illustrative example of the retrieval pipeline can be described in reference to a popular dish carousel that can be shown to end users in an application on the end user device. The popular dish carousel can display relevant dishes for queries that have a dish intent. This means that when end users search for “açai bowl,” “pad Thai,” “Hawaiian pizza,” etc. the end users are signaling that they are looking for a particular dish. Therefore, by providing the dishes directly in the search results page the computer can help end users quickly compare different options across many stores.

With the new query understanding and retrieval improvements, during experiments, a substantial increase in the trigger rate of “popular dish” carousels was recorded. Specifically, a 30% relative increase was observed compared to a baseline value, meaning more carousels are being displayed to end users looking for dishes, aligning the search results more closely with their intent.

This increase in trigger rate leads to more relevant results for end users. When queries are segmented accurately and linked to the knowledge graph, the computer can retrieve a broader and more precise set of items to populate these carousels. A higher trigger rate coupled with high quality results means that the overall relevance of displayed items is increased. This was measured by a whole page relevance (WPR) metric, which is designed to measure, from the end user's perspective, the overall relevance of the search results page across different query segments and intents. Systems and methods according to embodiments led to an increase in WPR for dish intent queries of over 2 percentage points, indicating that users were seeing more relevant dishes in their results.

Combining large language models for query understanding, the knowledge graph, and a flexible retrieval approach, enables the computer to handle complex and nuanced user queries and unlock new experiences in a highly dynamic environment.

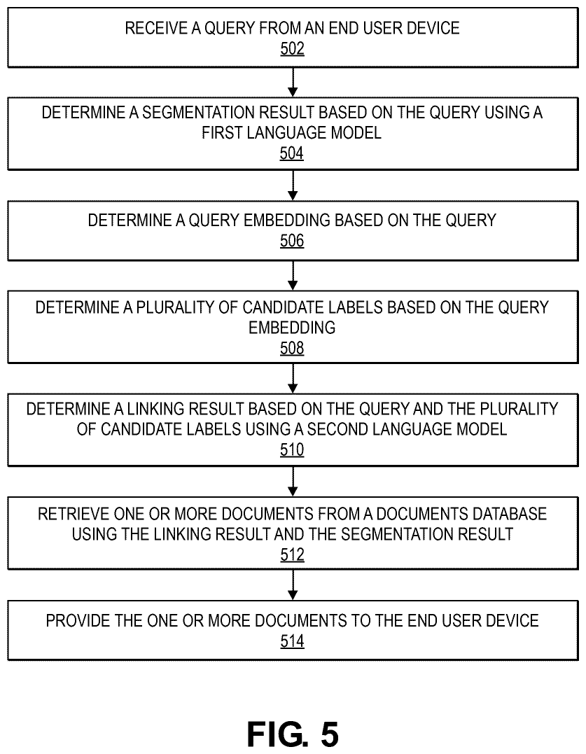

FIG. 5 shows a flowchart of a document retrieval method according to embodiments. The method illustrated in FIG. 5 can be performed by a computer, such as a central server computer. FIG. 5 will be described in the context of a computer receiving a query from an end user device and processing the query through a series of steps to deliver relevant search results. The computer determines a segmentation result for the query using a first language model, which parses the query into meaningful generated labels. The computer then generates a query embedding, which is a mathematical representation of the query, using machine learning techniques. Based on the query embedding, the computer identifies a plurality of candidate labels, which are potential classifications or categories relevant to the query. Subsequently, the computer determines a linking result by analyzing the query and the candidate labels using a second language model, effectively mapping the query to known labels within a label database. Leveraging both the linking result (which includes known labels) and the segmentation result (which includes generated labels), the computer retrieves one or more documents from a documents database that are most relevant to the user's query. Finally, these documents are provided to the end user device, completing the information retrieval cycle.

At step 502, the computer can receive a query from an end user device. The computer can receive the query from the end user device through an application (e.g., a delivery application, etc.) that is stored on the end user device. For example, the user of the end user device can input text into a search bar presented in the application. The application, in conjunction with the end user device, can provide the text as a query to the computer. The query can include a search for an item. The search can include text.

In some embodiments, after receiving the query, the computer can preprocess the query. The computer can modify the query to aid downstream processing. For example, the received query can be a raw search query, and the computer can preprocess the raw search query into a clean search query.

The computer can preprocess the query in any suitable manner. For example, the computer can modify the query to fix spelling of words in the query. As another example, the computer can determine a search intent of the query using a search intent classification process.

At step 504, after receiving the query, the computer can determine a segmentation result based on the query using a first language model (e.g., a first large language model). The segmentation result can include one or more generated labels that represent the query but are not necessarily labels that are indexed in a database, such as the document database.

To determine the segmentation result, the computer can determine a category template for the query. The computer can generate a prompt using the query and the category template. The computer can provide the prompt to the first language model to generate segmentation results in a particular format based on the query.

In some embodiments, the computer can determine the category template based on a taxonomy category. For example, the computer can determine a taxonomy category for the query. The computer can then determine the category template based on the taxonomy category.

At step 506, the computer can determine a query embedding based on the query. The computer can determine the query embedding using an embedding machine learning model that is trained to generate embeddings. The embedding machine learning model can accept text and input and can output numerical values that represent the text.

At step 508, the computer can determine a plurality of candidate labels based on the query embedding. To determine the plurality of candidate labels, the computer can compare the query embedding to a plurality of labels stored in a label database to determine a plurality of similarity scores. The computer can select a subset of labels from the plurality of labels based on the plurality of similarity scores. The subset of labels is the plurality of candidate labels. The candidate labels can include, for example, cuisine related labels, dish type related labels, and/or dietary preference related labels.

At step 510, after determining the plurality of candidate labels, the computer can determine a linking result. The linking result can include one or more known labels that represent the query. The one or more known labels are labels that are indexed in a database, such as the document database. The computer can determine the linking results based on the query and the plurality of candidate labels using a second language model.

At step 512, after determining the linking result, the computer can retrieve one or more documents from the documents database using the linking result and the segmentation result. Each document of the one or more documents is a document for an item or a store.

The computer can obtain retrieved documents from the documents database using the one or more known labels that represent the query of the linking result. For example, the computer can search the documents database for documents that are stored in association with a label that matches at least one label as indicated in the linking result.

After obtaining the retrieved documents, the computer can filter the retrieved documents using the segmentation result to determine the one or more documents. For example, the computer can, for each document of the retrieved documents, determine whether or not the document includes text that matches the one or more generated labels in the segmentation result. If the document includes text that matches the one or more generated labels in the segmentation result, then the computer can add the document to the one or more documents that are to be provided to the end user device.

In some embodiments, the computer can also rank the one or more documents using the segmentation result. The computer can rank the one or more documents based on a number of known labels associated with each document. For example, a first document may be stored in association with three known labels from the linking result (e.g., dish type=wings, taste=spicy, and protein=chicken), while a second document may be stored in association with one known label from the linking result (e.g., taste=spicy). The first document can be ranked higher in the list of the one or more documents since the first document has more known labels that relate to the query.

At step 514, the computer can provide the one or more documents to the end user device in response to the query. The end user device can display the one or more documents to the user via a screen or other display means. The end user device can prompt the user to select a document for the one or more documents for the end user to obtain from the resource provider via a transporter.

Embodiments of the disclosure provide a number of technical and practical advantages over conventional search and query processing systems. One advantage is the use of large language models (LLMs) to perform accurate segmentation and linkage of user queries to a knowledge graph's controlled vocabulary. By harnessing the advanced contextual understanding capabilities of LLMs, embodiments effectively address the limitations inherent in traditional query processing methods, such as pointwise mutual information, n-gram analysis, and basic rule-based or statistical techniques, which are often incapable of resolving ambiguity or capturing the broader contextual and semantic relationships present in complex or nuanced queries.

Traditional query processing systems typically rely on statistical co-occurrence or manual rules, which lack the ability to incorporate external knowledge or understand the intent behind user queries, particularly when those queries are ambiguous, compound, or previously unseen. In contrast, embodiments utilize LLMs that are pre-trained on vast corpora of textual data, thereby imbuing the system with a level of general “world knowledge” and contextual awareness that enables more accurate disambiguation and interpretation of user inputs. The integration of this world knowledge with a domain-specific controlled vocabulary, as included in the knowledge graph, allows for robust and scalable mapping of user queries to relevant entities, attributes, and relationships within the underlying dataset.

The architecture according to embodiments provides for a number of advantages. First, by improving the precision with which user queries are segmented and mapped to structured representations, the system is able to retrieve search results that are significantly more relevant to the user's actual intent. For example, ambiguous queries that previously yielded imprecise or extraneous results can now be resolved to the most contextually appropriate items, categories, or documents. Second, the use of LLMs allows the system to adapt to a wide variety of user expressions, including those that use novel phrasing, synonyms, or colloquial language, thereby reducing the need for continual manual intervention or rule maintenance. Third, the combination of LLMs with domain-specific knowledge graphs ensures that results are not only contextually accurate in a general sense, but are also tailored to the specific requirements, terminology, and conventions of the relevant domain.

Furthermore, these technical advantages translate directly into enhanced user engagement and satisfaction. As users receive more accurate and contextually relevant search results, they are more likely to find the information or products they seek efficiently, which in turn increases the overall effectiveness and adoption of the search system. The scalable nature of this approach means that it can be deployed across large datasets and complex domains without suffering from the bottlenecks or maintenance burdens associated with manual or purely statistical systems.

As such, embodiments of the disclosure achieve a transformative increase in search relevance and user engagement by combining the contextual and semantic strengths of large language models with the precision and structure of domain-specific knowledge graphs. This results in a search system that delivers highly accurate, context-aware results at scale, overcoming the limitations of traditional query processing methods and providing substantial benefits to both end users and system operators.

Although the steps in the flowcharts and process flows described above are illustrated or described in a specific order, it is understood that embodiments of the invention may include methods that have the steps in different orders. In addition, steps may be omitted or added and may still be within embodiments of the invention.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a computer, a query from an end user device;
determining, by the computer, a segmentation result based on the query using a first language model;
determining, by the computer, a query embedding based on the query;
determining, by the computer, a plurality of candidate labels based on the query embedding;
determining, by the computer, a linking result based on the query and the plurality of candidate labels using a second language model;
retrieving, by the computer, one or more documents from a documents database using the linking result and the segmentation result; and
providing, by the computer, the one or more documents to the end user device.

2. The method of claim 1, determining the query embedding comprises:
determining, by the computer, the query embedding using an embedding machine learning model that is trained to generate embeddings.

3. The method of claim 1, wherein each document of the one or more documents is a document for an item or a store, and wherein the method further comprises:
receiving, by the computer from the end user device, a fulfillment request message comprising at least one item provided by a service provider associated with the image;
providing, by the computer, the fulfillment request message to a service provider computer operated by the service provider, wherein the service provider initiates preparation of at least the item;
determining, by the computer, one or more transporter user devices;
providing, by the computer, the fulfillment request message to the one or more transporter user devices, wherein the one or more transporter user devices determine whether or not to request to accept the fulfillment request message;
receiving, by the computer, an acceptance message from a transporter user device of the one or more transporter user devices;
generating, by the computer, an update message indicating a status of the fulfillment request message; and
providing, by the computer, the update message to the end user device.

4. The method of claim 1, wherein determining the segmentation result comprises:
determining, by the computer, a category template for the query;
generating, by the computer, a prompt using the query and the category template; and
providing, by the computer, the prompt to the first language model to generate the segmentation result in a particular format based on the query.

5. The method of claim 4, wherein determining the category template comprises:
determining, by the computer, a taxonomy category for the query; and
determining, by the computer, the category template based on the taxonomy category.

6. The method of claim 1, wherein determining the plurality of candidate labels comprises:
comparing, by the computer, the query embedding to a plurality of labels stored in a label database to determine a plurality of similarity scores; and
selecting, by the computer, a subset of labels from the plurality of labels based on the plurality of similarity scores, wherein the subset of labels is the plurality of candidate labels.

7. The method of claim 1, wherein determining the linking result comprises:
generating, by the computer, a prompt based on the query and the plurality of candidate labels; and
determining, by the computer, the linking result using the second language model and the prompt.

8. The method of claim 1, wherein the linking result includes one or more known labels that represent the query, wherein the one or more known labels are labels that are indexed in the document database, and wherein the segmentation result includes one or more generated labels.

9. The method of claim 8, wherein retrieving the one or more documents from the documents database using the linking result and the segmentation result comprises:
obtaining, by the computer, retrieved documents from the documents database using the one or more known labels that represent the query of the linking result; and
filtering, by the computer, the retrieved documents using the segmentation result to determine the one or more documents.

10. The method of claim 9, wherein filtering the retrieved documents comprises:
for each document of the retrieved documents, determining, by the computer, whether or not the document includes text that matches the one or more generated labels in the segmentation result; and
if the document includes text that matches the one or more generated labels in the segmentation result, adding the document to the one or more documents that are to be provided to the end user device.

11. The method of claim 10 further comprising:
ranking, by the computer, the one or more documents using the segmentation result.

12. The method of claim 1, further comprising:
after receiving the query, preprocessing, by the computer, the query.

13. The method of claim 12, wherein preprocessing the query comprises:
modifying, by the computer, the query to fix spelling of words in the query; and
determining, by the computer, a search intent of the query using a search intent classification process.

14. A computer comprising:
a processor; and
a non-transitory computer readable medium comprising code, executable by the processor for performing operations comprising:
receiving a query from an end user device;
determining a segmentation result based on the query using a first language model;
determining a query embedding based on the query;
determining a plurality of candidate labels based on the query embedding;
determining a linking result based on the query and the plurality of candidate labels using a second language model;
retrieving one or more documents from a documents database using the linking result and the segmentation result; and
providing the one or more documents to the end user device.

15. The computer of claim 14, wherein the query includes a search for an item, wherein the search includes text and wherein the one or more documents represent items.

16. The computer of claim 14, wherein the plurality of candidate labels include cuisine related labels, dish type related labels, and/or dietary preference related labels.

17. The computer of claim 14, wherein receiving the query comprises:
receiving the query from an application installed on the end user device, and wherein providing the one or more documents to the end user device comprises:
providing the one or more documents to the application.

18. The computer of claim 14, wherein the segmentation result includes one or more generated labels, and wherein determining the segmentation result comprises:
determining a taxonomy category for the query;
determining a category template based on the taxonomy category;
generating a prompt using the query and the category template; and
providing the prompt to the first language model to generate the segmentation result.

19. The computer of claim 14, wherein the computer is a central server computer.

20. A system comprising:
an end user device;
a documents database; and
a central server computer comprising:
a processor; and
a non-transitory computer readable medium comprising code, executable by the processor for performing operations comprising:
receiving a query from the end user device;
determining a segmentation result based on the query using a first language model;
determining a query embedding based on the query;
determining a plurality of candidate labels based on the query embedding;
determining a linking result based on the query and the plurality of candidate labels using a second language model;
retrieving one or more documents from the documents database using the linking result and the segmentation result; and
providing the one or more documents to the end user device.
